(19) United States
(12) Patent Application Publication
(10) Pub. No.: US 2026/0156028 A1
(43) Pub. Date: Jun. 4, 2026

(54) COMMUNICATING BASED ON NETWORK CONFIGURATION IDENTIFIER SHARING

(71) Applicant: Telefonaktiebolaget LM Ericsson (publ), Stockholm (SE)

(72) Inventors: Adrian GARCIA RODRIGUEZ, PARIS (FR); Mårten SUNDBERG, ÅRSTA (SE); David SANDBERG, SUNDBYBERG (SE); Jingya LI, GÖTEBORG (SE); Henrik RYDÉN, STOCKHOLM (SE)

(73) Assignee: Telefonaktiebolaget LM Ericsson (publ), Stockholm (SE)

(21) Appl. No.: 19/127,124

(22) PCT Filed: Nov. 3, 2023
(86) PCT No.: PCT/SE2023/051116

§ 371 Date: May 4, 2025

(30) Foreign Application Priority Data
Nov. 4, 2022 (WO) PCT/IB2022/000794

(51) Int. Cl. H04L 41/0803; H04L 41/14

(52) U.S. Cl. CPC H04L 41/0803; H04L 41/145

(57) ABSTRACT

A communication device in a communications network that includes a first network node can receive an indication of a network configuration identifier, ID, from the first network node. The network configuration ID can be associated with a future network configuration. The communication device can r determine whether a current model supports the future network configuration. The communication device can determine a future model based on determining whether the current model supports the future network configuration. The communication device can receive an indication of when the future network configuration will be active. Subsequent to receiving the indication that the future network configuration is active, the communication device can communicate with a second network node using the future model.

### TECHNICAL FIELD

The present disclosure is related to wireless communication systems, communication devices, network nodes, systems, and hosts for communication based on network configuration identifier sharing.

### BACKGROUND

FIG. 1 illustrates an example of a New Radio (“NR”) network (e.g., a 5th Generation (“5G”) network) including a 5G Core (“5GC”) network 130, network nodes 120 a-b (e.g., 5G base station (“gNB”)), multiple communication devices 110 (also referred to as user equipment (“UE”)).

Artificial intelligence (“AI”) and machine learning (“ML”) can be promising tools to optimize the design of air-interfaces in wireless communication networks. In some examples, autoencoders for channel state information (“CSI”) compression can be used to reduce feedback overhead and improve channel prediction accuracy. In additional or alternative examples, deep neural networks for classifying line-of-sight (“LOS”) and non-line-of-sight “(NLOS”) conditions can be used to enhance positioning accuracy. In additional or alternative examples, reinforcement learning for beam selection at the network side and/or the UE side can be used to reduce the signaling overhead and beam alignment latency.

Some Third Generation Partnership Project (“3GPP”) study items are exploring the benefits of augmenting the air-interface with features enabling improved support of AI/ML based algorithms for enhanced performance and/or reduced complexity/overhead. Through studying a few selected use cases (e.g., CSI feedback, beam management and positioning), these study items aim at laying the foundation for future air-interface use cases leveraging AI/ML techniques.

When applying AI/ML on air-interference use cases, different levels of collaboration between network nodes and UEs can be considered. The different levels of collaboration can include: 1) no collaboration between network nodes and UEs; 2) limited collaboration; and 3) joint ML operation between network nodes and UEs. In some examples, when there is no collaboration between network nodes and UEs, a proprietary ML model operating with the existing standard air-interface can be applied at one end of the communication chain (e.g., at the UE side). In additional or alternative examples, when there is limited collaboration between network nodes and UEs, a ML model is operating at one end of the communication chain (e.g., at the UE side), but this node gets assistance from the node(s) at the other end of the communication chain (e.g., a gNB) for its AI model life cycle management (e.g., for training/retraining the AI model, model update). In additional or alternative examples, when there is joint ML operation between network nodes and UEs, it can be assumed that the AI model is split with one part located at the network side and the other part located at the UE side. Hence, the AI model can require joint training between the network and UE, and the AI model life cycle management involves both ends of a communication chain.

Herein the level of collaboration is generally assumed to fall into the category of limited collaboration between network nodes and UEs. Therefore, it is generally assumed that one or multiple proprietary model/s operating with the existing standard air-interface is/are placed at the UE side.

Within that context, this specification generally focuses on the case where the UE vendors are interested in using information pertaining the network hardware and/or software features as contextual information for one or more of the proprietary models implemented at the UE. Intuitively, such information may be used by the UE vendor to, for example, reduce AI/ML model training time and/or to enhance AI/ML model performance. For example, an ML-based UE model for CSI reporting that determines the rank indicator (“RI”) to recommend a subsequent downlink transmission rank by the network may explicitly use the knowledge of whether the network is utilizing one link adaptation algorithm or another as an input to enhance the RI recommendations.

Providing a ML-model with a rich context, explicitly or implicitly describing the current conditions the model is operating in can improve performance. One such example is illustrated in FIG. 2, where a model is trained to soft demap (essentially estimating the probability that a 1 or a 0 was transmitted) in a phase noise impaired system. The model is trained to handle a wide range of noise components from severely phase noise limited to only thermal noise limited (and anything in-between, e.g., a mix of phase noise and thermal noise).

If such a model is trained without providing a context of what type of noise is seen, a typical NN-implementation would provide a point estimate of each received sample. However, if a context is provided as input, such context can help steer the algorithm to separate different operating conditions and hence improve performance (rather than averaging across all conditions). One example of gains with such a context-aware receiver is shown in FIG. 2.

As can be seen in FIG. 2, performance is clearly improved by providing such context. In this case, the context was implicit (e.g., without a physical meaning except for the algorithm it has been trained on).

FIG. 3 illustrates that the UEs can share their radio capability IDs with the network. In some examples, a message includes a unique UE vendor ID issued by the Internet Assigned Numbers Authority (“IANA”) and the radio capability identifier (“RCI”) identifying the UE radio configuration.

In additional or alternative examples, a procedure is provided that focuses on beam management where the network provides a configuration ID to the UE pertaining the beamforming configuration at the network. Such beamforming configuration may include the angular and related information (e.g., main lobe azimuth and elevation angles, and beamwidth). This could facilitate the identification of spatial consistency in the network behavior enabling the UE to build, e.g., ML models that exploit such consistency.

In additional or alternative examples, a procedure is provided for signaling and/or reporting a first node to provide beamforming-related information to a second node. The beamforming-related information indicates at least the spatial information of one or more reference signaling beam(s) transmitted from the first node, and this information is used by the second node to perform prediction of the quality of beam pairs between itself and the first node.

### SUMMARY

There currently exist certain challenges. With the expected increased user equipment (“UE”) intelligence capabilities (as e.g., per the Rel-18 study item on artificial intelligence (“AI”)/machine learning (“ML”) of the Third Generation Partnership Project (“3GPP”)), it is expected that UEs will aim at using contextual information about the network nodes configuration / operating conditions to enhance their performance.

However, while the benefits of using such network configuration information can be clear, vendors are typically not keen on disclosing an excessive number of details about their products to the UEs, since this disclosure may harm their competitiveness.

Furthermore, with a data-driven approach providing network configuration as input to a trained model, if the trained model would experience an unseen network configuration, the model behavior would be unknown.

Overall, the state-of-the-art fails to suffice to enable an adequate sharing and management of network configuration IDs. In some examples, existing procedures do not consider the case where UEs using one or more models that leverage the network configuration ID may not explicitly support a specific network configuration ID (e.g., a model is using the network configuration ID as a contextual feature as input to the model, but the model has not been trained with a specific network configuration ID and hence the model performance is unknown) active at a given point in time, which will lead to the UE model performance degradation.

In additional or alternative examples, existing procedures do not disclose solutions to establish relationships among different configurations and hence prevents a UE from generalizing to unseen configurations.

Certain aspects of the disclosure and their embodiments may provide solutions to these or other challenges. In some embodiments, a procedure is provided that enables improved performance of AI/ML models at the UE, by signaling one or more network configuration IDs to the UE. Improved performance can be achieved by providing such network configuration IDs as contextual input to the AI/ML model at the UE. Since the UE performance would be unknown when providing an unseen (e.g., during training of the model) network configuration ID to the model, the invention establishes a procedure to allow a stable model management and update of models (e.g., to handle the unseen configuration IDs) in case of such event.

According to some embodiments, a method of operating a communication device in a communications network that includes a first network node is provided. The method includes receiving an indication of a network configuration identifier, ID, from the first network node.

The network configuration ID is associated with a future network configuration. The method further includes determining whether a current model supports the future network configuration. The method further includes determining a future model based on determining whether the current model supports the future network configuration. The method further includes receiving an indication of when the future network configuration will be active. The method further includes subsequent to receiving the indication that the future network configuration is active, communicating with a second network node using the future model.

According to other embodiments, a method of operating a communication device in a communications network that includes a first network node is provided. The method includes receiving a message from the first network node. The message indicates a set of one or more network configuration identifiers, IDs, that are each associated with network configurations.

The method further includes determining whether to adjust information stored in a memory associated with the communication device based on the set of one or more network configuration IDs.

According to other embodiments, a method of operating a network node in a communications network that includes a communication device is provided. The method includes transmitting an indication of a first network configuration identifier, ID, to the communication device. The first network configuration ID is associated with a first network configuration. The method further includes transmitting an indication of a second network configuration ID to the communication device. The second network configuration ID is associated with a future network configuration.

According to other embodiments, a communication device, network node, system, computer program, computer program product, non-transitory computer-readable medium, or host is provided to perform one or more of the above methods.

Certain aspects of the disclosure and their embodiments may provide technical advantages. In some examples, a key advantage of the proposed embodiments is that the performance of UE models that use the network configuration ID as an input is not likely to be degraded when such network configuration ID is modified. In additional or alternative examples, changes in the network configuration may be communicated to the UE beforehand, which allows UEs to obtain and activate models that explicitly support the relevant network configuration ID, whenever possible. In additional or alternative embodiments, the network may explicitly or implicitly communicate a relation among different network configuration IDs to the UE. By receiving such indication, the UE can leverage learnings among a set of IDs.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a graph illustrating an example of an importance of a context-aware ML-model;

FIG. 3 is a diagram illustrating an example of a UE radio capability ID;

FIG. 4 is a signal flow illustrating an example of network configuration ID sharing and communication device adjustment in accordance with some embodiments;

FIG. 5 is a table illustrating an example of a network configuration in accordance with some embodiments;

FIGS. 6-7 is a flow chart illustrating an example of a network feature field abstraction in accordance with some embodiments;

FIG. 8 is a block diagram illustrating an example of a network configuration ID in accordance with some embodiments;

FIG. 9 is a block diagram illustrating an example of an embedded network configuration ID in accordance with some embodiments;

FIGS. 10-11 are flow charts illustrating an example of operations performed by a communication device in accordance with some embodiments;

FIG. 12 is a flow chart illustrating an example of operations performed by a network node in accordance with some embodiments;

FIG. 13 is a block diagram of a communication system in accordance with some embodiments;

FIG. 14 is a block diagram of a user equipment in accordance with some embodiments FIG. 15 is a block diagram of a network node in accordance with some embodiments;

FIG. 16 is a block diagram of a host, which may be an embodiment of the host of FIG. 13, in accordance with some embodiments;

FIG. 17 is a block diagram of a virtualization environment in accordance with some embodiments; and

FIG. 18 shows a communication diagram of a host communicating via a network node with a user equipment over a partially wireless connection in accordance with some embodiments.

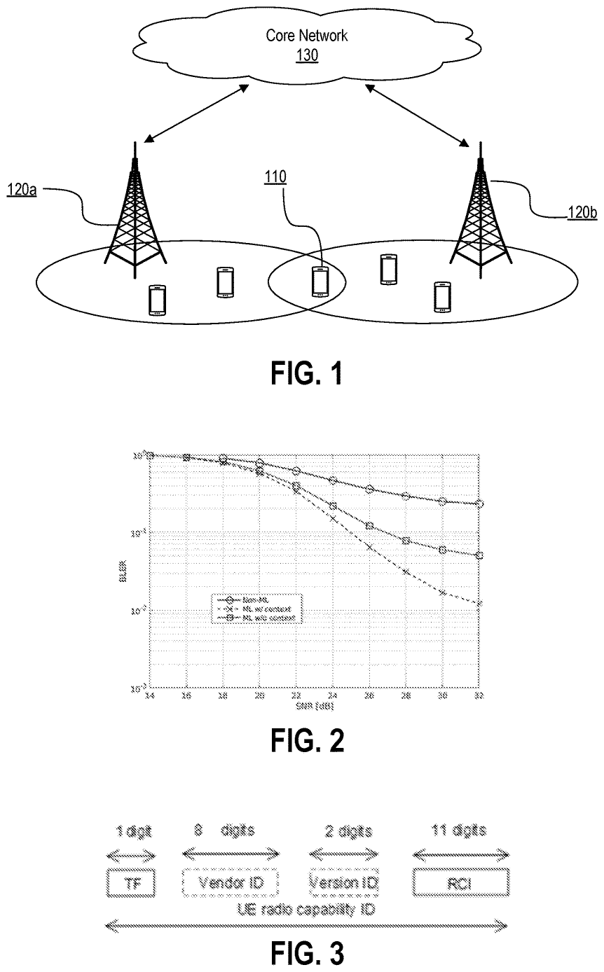

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In some embodiments herein, the concept of ‘network’ can be understood as a generic network node, gNB, base station, unit within the base station to handle at least some machine learning (“ML”) operation, relay node, core network node, a core network node that handle at least some ML operations, or a device supporting device-to-device (“D2D”) communication.

In additional or alternative embodiments herein, a model may refer to an ML-based model, a configuration of an ML-based model, a non-ML-based functionality, or a configuration of a non-ML-based functionality.

In additional or alternative embodiments, the terms “ML-model” and “AI-model” are interchangeable. An artificial intelligence (“AI”)/ML model can be defined as a functionality or be part of a functionality that is deployed/implemented in a first node. This first node can receive a message from a second node indicating that the functionality is not performing correctly. Further, an AI/ML model can be defined as a feature or part of a feature that is implemented/supported in a first node. This first node can indicate the feature version to a second node. If the ML-model is updated, the feature version maybe changed by the first node.

Various embodiments herein are related to wireless communication systems, and more particularly to adjusting operation of a communication device based on receiving an indication of a network configuration identifier associated with a future network configuration.

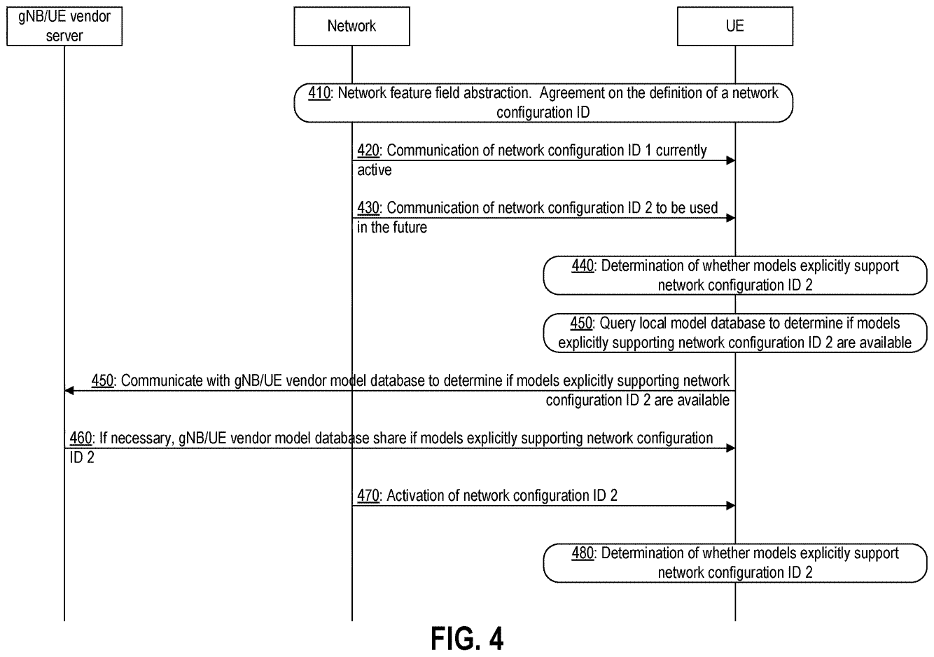

FIG. 4 illustrates an example of a network configuration ID sharing and UE adjustment. In some embodiments, only a subset of the steps/signaling may be executed.

At block 410, a network configuration ID is defined. Prior to its indication in block 420, the network and the UE agree on the definition of a network configuration ID. In some embodiments, such agreement may be detailed in a standard specification. In additional or alternative embodiments, a bi-lateral agreement among network and UE vendors may be reached. The network configuration ID will include at least one of the following network feature fields: network vendor ID field; network configuration version ID field; network hardware ID field; network software ID field; network procedure ID field; network load state ID field; network spatial multiplexing ID field; network energy saving ID field; and network scenario ID field.

In some examples, the network vendor ID field may be defined in accordance with an external organization to avoid duplications among network vendors.

In additional or alternative examples, the network configuration version ID field, associated with the network vendor ID, indicates the version of the ID mapping used. This field may be used to differentiate among different versions of the other ID fields (e.g., when running out of ID fields for a specific version ID field value) to clearly separate old products from new products (e.g., 6G vs. 6G Advanced), or when using different versions of the embeddings.

In additional or alternative embodiments, the network hardware ID field identifies the network product version characterizing a given physical hardware architecture (e.g., a certain antenna configuration and physical to virtual antenna port mapping).

In additional or alternative embodiments, the network software ID field identifies the network product version characterizing a given software release.

In additional or alternative embodiments, the network procedure ID field represents the procedure that the network uses for link adaptation, which may impact, for example, UE models for CSI reporting.

In additional or alternative embodiments, the network load state ID field represents the cell load, which may impact, for example, UE models for carrier selection.

In additional or alternative embodiments, the network spatial multiplexing ID field represents the multiple-input multiple-output (“MIMO”) characteristics of the cell, for example, the maximum number of UEs that the network can spatially multiplex with multi-user MIMO (“MU-MIMO”), statistical information pertaining the number of spatial layers scheduled per time/frequency resource, or statistical information pertaining the number of UEs scheduled per time/frequency resource (single-user MIMO vs. MU-MIMO). This may impact, for example, the UE models for CSI reporting.

In additional or alternative embodiments, the network energy saving ID field represents the energy saving features activated/deactivated of the cell/network, for example, parts of the antenna elements is switched off or parts of the network nodes (e.g., gNB-DUs, TPRs, access points) are switched off, which may impact, for example, UE models for beam prediction or/and positioning.

In additional or alternative embodiments, the network scenario ID field represents the type of scenario where the network is deployed (e.g., indoor, urban, or macro). In additional or alternative embodiments, the network may define the scenarios based on the distribution of the wireless channel measured for a given cell and comparing such measurements with those found in other previously labelled scenarios (e.g., via unsupervised learning/clustering). This may impact, for example, the UE models for CSI reporting.

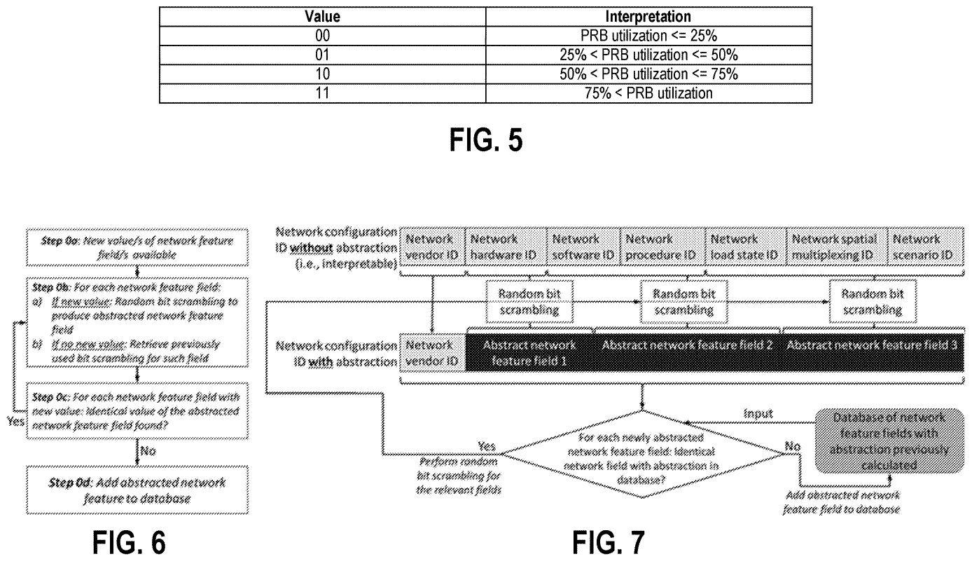

In some embodiments, one or several of the above-mentioned network feature fields may be interpretable by the UE. For example, a subfield PRB Utilization in the Network load state ID field may be interpreted as shown in FIG. 5.

FIG. 5 illustrates an example of the interpretation of a subfield PRB Utilization within the Network load state ID field. The meaning of the values are provided, for example, in the specification, and therefore are interpretable by the UE.

In some embodiments, one or several of the above-mentioned interpretable network feature fields (e.g., all but the network vendor ID) may be merged into a single or multiple abstract network feature fields-therefore concealing the interpretation of the features implemented or active at networks-and included into the network configuration ID. FIG. 4 illustrates how the network may perform such abstraction in a proprietary manner. In essence, for each new value of one or multiple non-abstracted network feature fields, the network may perform a random scrambling of the bits of such network feature field/s while ensuring that the same scrambled sequence has not been utilized in the past.

FIG. 6 illustrates an example of a flow chart and FIG. 7 illustrates an example of a network feature field abstraction performed in some embodiments by the network.

Returning to FIG. 4, at block 420, the network communicates the current configuration ID to the UE. In some embodiments, the network communicates the network configuration ID corresponding to the network configuration currently active (network configuration ID 1) to one or more UEs.

In additional or alternative embodiments, the network may communicate the current or a future network configuration ID (see Block 430) may be realized in a broadcast, multicast, or unicast manner.

In some examples, the network may communicate the network configuration ID using broadcast network configuration ID transmission. This may enable the reception of such network configuration ID to all UEs associated to a given cell. In this way, the network does not have to consider whether or how such information may be later used by the associated UEs. This may also facilitate the reception of such network configuration ID by UEs associated to neighboring cells, which may use such information, for example, to influence their handover decisions. The network configuration ID can be broadcasted in cell-specific system information message(s), for example, SIB message(s), or it can be broadcasted from multiple cells in a synchronized single-frequency network (“SFN”) fashion, if these cells have the same network configuration ID. For D2D cases, the network configuration ID can also be broadcasted in sidelink system information message(s) or broadcasted as sidelink data payload over the physical sidelink shared channel(s).

In additional or alternative examples, the network may communicate the network configuration ID using multicast/unicast network configuration ID transmission. In this case, the network configuration ID can be signaled to the UE via UE-specific RRC signaling, MAC CE(s), a DCI/SCI format(s). The network configuration ID can also be carried on a physical downlink shared channel, a physical sidelink shared channel, or a physical sidelink feedback channel.

This may be preferred when the network is interested in only transmitting the network configuration ID to a subset of UEs. For example, when the network is interested in having a tighter control of the network load. For instance, if there are a large number of UEs that may require a model update to support an updated network configuration ID, each of those UEs may request the transfer of an updated model over-the-air (see blocks 450 and 460). Since each of such model transfers introduce additional network load, the network may want to avoid the simultaneous triggering of a large number of UE model update requests.

This may be preferred when the network only wants to share the network configuration ID with those UEs that will explicitly use such information. In some embodiments, the network explicitly identifies the UEs that want to make use of the network configuration ID via, for example, the reception of an explicit network configuration ID request from the UEs, or the presence of a UE capability field indicating the utilization of the network configuration ID by one or more models at the UE.

At block 430, the network communicates a future configuration ID to the UE. In some embodiments, the network may also indicate to one or multiple UEs that a network configuration ID (network configuration ID 1) is going to be updated/replaced by a different value (network configuration ID 2) some time in the future. For instance, this may occur when the network operator is planning to upgrade the infrastructure with a new gNB hardware and/or software product from a network vendor.

In additional or alternative embodiments, the network may specify the time instant where the change will take place by communicating, for example, the absolute time (year, month, hour, minute, seconds), or the relative time from the moment the message was transmitted (e.g., in number of system frame numbers (SFNs), time slots, OFDM symbols, etc.), or associate the time instant with a specific control signaling transmission or a specific RS transmission (e.g., network configuration ID 2 should be applied since the UE receiving the first symbol of the physical downlink shared channel carrying an RRC signaling for CSI measurement configuration, or network configuration ID 2 should be applied since the UE receiving the first symbol of the next DL-RS burst transmission occasions).

At block 440, the UE determines if models explicitly support the relevant network configuration ID. In some embodiments, if a UE executes and/or may potentially execute one or more models that utilize the network configuration ID as input, and one or more of such models do not explicitly support network configuration ID 2, the UE may trigger a request to a database to determine if updated versions of the models explicitly supporting network configuration ID 2 can be made available. In some examples, in the case of AI/ML models, explicit support of a given network configuration ID can be interpreted as, for example, AI/ML models that have been trained in setups with network/s with such network configuration ID, and/or the AI/ML models those performance has been evaluated and deemed as adequate when executed with network/s with such network configuration ID.

The UE may make determination of whether a model explicitly supports a network configuration ID based on, in some examples, a first set of databases which, for each model, indicate the network configuration IDs explicitly supported by such model. In additional or alternative examples, the UE may make the determination based on whether the proximity of the network configuration ID 2 to another network configuration ID explicitly supported by such model in a distance metric is below/above a given value.

At block 450, if necessary, the UE determines if models that explicitly support the relevant network configuration ID can be made available. If, as per block 440, the UE determines that one or more of the models currently active do not explicit support a network configuration ID 2, the UE will query one or more of a second set of model databases and attempt to determine whether such databases contain models performing the same functionality but explicitly supporting network configuration ID 2. The second set of model databases may be located in memories available, for example, locally at the UE, in a server managed by the UE vendor, and/or in a server managed by the network vendor.

In additional or alternative embodiments, the second set of model databases are not found locally at the UE, the UE will transmit the query to one or more servers, which will then reply to the UE with a message (sometimes referred to as model availability response message) at least indicating whether the models supporting network configuration ID 2 are available or not.

At block 460, if necessary and whenever possible, the UE receives and prepares the models that explicitly support the relevant network configuration ID. In some embodiments, where the second set of model databases are located at gNB-or UE-managed servers, the servers may share the queried models explicitly supporting network configuration ID 2 with a message (sometimes referred to as model transfer message). In additional or alternative embodiments, the model transfer message may be part of the model availability response message introduced in block 450.

At block 470, the network uses and signals activation of network configuration ID 2. At the time instant where the network configuration ID change takes place and the network configuration ID 2 becomes active, the network communicates the network configuration ID as per block 420.

At block 480, the UE adjusts its operation to support network configuration ID 2. In some embodiments, upon reception of the message, the UE/s that explicitly use the network configuration ID information in one or more models will keep active those models that explicitly support network configuration ID 2. In additional or alternative embodiments, upon reception of the message, the UE/s that explicitly use the network configuration ID information in one or more models will switch the active models that do not explicitly support network ID 2 by models that explicitly support network ID 2, if the latter are available as per block 460.

In some examples, if the one or more active models of the UE that do not explicitly support network ID 2 do not contain updated versions that explicitly support network ID 2, the UE may switch the models that do not support network ID 2 by a different model available at the UE (e.g., an ML model is switched by a non-ML model). In some examples, the UE enters a model performance monitoring phase for the models that do not support network ID 2. In additional or alternative examples, the UE enters a data collection phase to retrain the models that do not support network ID 2.

In some embodiments, the network explicitly indicates a relation among a pair of network configuration IDs. In some examples, during block 430, the network may also indicate a relation score among different network configuration IDs. This can be used by the UE to decide whether to use the network configuration ID as an input to the model while training, for example as a one-hot encoded value. By receiving an indication of the relation among network configuration IDs, the UE can utilize learnings among a set of IDs.

The NW can, for example, indicate a set of values including an indication of network configuration ID1, an indication of network configuration ID2, and a relation-score.

The relation-score can include a value between 0-10, where 0 means uncorrelated while 10 means high correlation. As an example, consider the scenario when the ID indicates an antenna configuration, for example ID1 represents an antenna of size 8×32 elements, ID2 represents an antenna of size 8×16 elements, ID3 represents an antenna of size 2×4 elements. The beamforming capabilities ID1 would be more similar to ID 2 than ID 3. The UE could hence receive a higher relation score for such scenarios and train a model valid for both ID1 and ID2, and a separate model for ID3. In some embodiments, such relation-score may be computed based on the comparison of one or multiple key performance indicators (e.g., maximum throughput) of the systems with network configuration ID1 and ID2. Note that utilizing learnings among IDs can reduce the need for data collection and model storage overhead.

In some embodiments, the network indicates implicit relation between network configuration IDs. In some examples, the underlying functionality communicated by the ID is abstract in the sense that the UE will receive an ID without any information specifying what is implied by the communicated ID. Such, implied information has to be learned. An efficient way of learning such one-hot encoded information (a set of possible code points in a bit vector) is to convert it through an embedding, producing an N-dimensional representation of the M-dimensional binary vector. In contrast to the binary vector, if an embedding is close (by a proximity measure in the N-dimensional vector space) to another, this means the implied information is also close (and this information can be used by the trained model for a more efficient and accurate inference).

In additional or alternative embodiments, the network transmits an embedded network ID which typically would be a quantized real valued vector. The benefit compared to other embodiments can be that if such embedding is used, the model can generalize to unseen embeddings and hence unseen network configurations, and would not strictly require any actions, if receiving an unseen embedded network configuration ID.

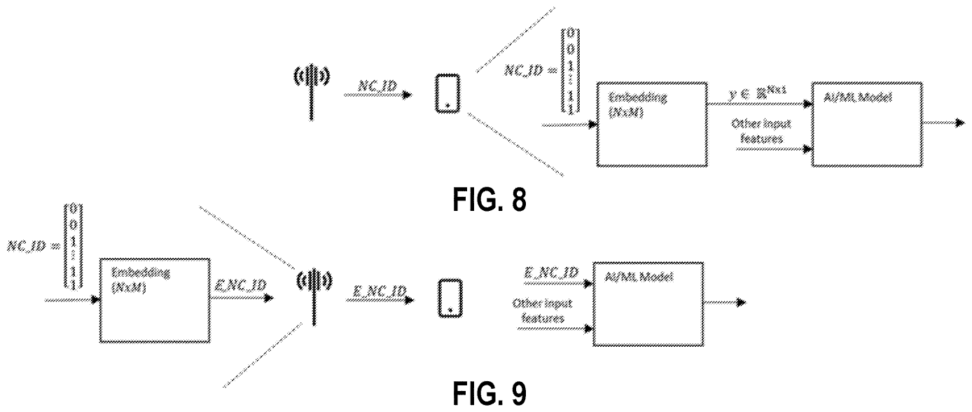

FIG. 8 illustrates an example of an implementation of the regular network configuration ID, where the UE constructs such embedding through training of the model. FIG. 9 illustrates an example of an implementation in which the embedding is put under network responsibility. In these examples, an embedding would have to be trained that generalizes across multiple UE AI/ML models. This is similar to word embeddings trained on a large set of text corpus and is later used in training of a wide range of language models.

In some embodiments, the UE requests configuration ID for model management. In some examples, the UE can request information of a set of network configuration IDs to check if such IDs are still valid or planned to be used by the network in the future. For example, if the ID related to certain hardware is no longer operational and the UE can therefore take actions to delete models related to such ID. In another example, the configuration ID signaled from the network has an associated validity time, defining how long time the ID is valid.

In some examples, the action to request information related to configurations IDs, and possibly delete one or more models could be executed: 1) when the cache/RAM/HDD is full at the device; 2) when configured to receive a new model; 3) when a validity time associated to the network configuration ID expires. The network may configure an expected time a given network configuration ID is valid; 4) after performing a handover to a new radio access node; 5) when the tracking area changes/operator/or country code changes; or 6) at a periodic time interval, the UE checks for potential removal of network configuration IDs, e.g., once per month.

In additional or alternative embodiments, the network can indicate the frequency of using a certain network configuration ID (e.g., in x % of the cells in a certain area based on, e.g., a tracking area code), since this could impact the model management at the device. For example, for network configuration IDs that are infrequent, the related model may not be deleted per se, but moved between different memory entities, e.g., from the UE cache-memory to UE Random-access memory (RAM), or from RAM to hard disk drive (HDD). Such model movement can be made based on, e.g., the number of times the related network configuration ID has been indicated, and/or the execution time constraints of the model, and/or the time elapsed between the model configuration or the determination that the model needs to be used and the obtention of a model output. For instance, since loading from RAM is typically much faster than loading models from the HDD, the UE risks having larger execution times for models stored in HDD, in comparison to models stored in cache-memory.

In some embodiments, the network indicates network configuration IDs of neighboring cells. In some examples, the network also indicates network configuration IDs of its neighboring cells. This could be useful for UEs with high mobility to decide whether to activate/deploy models that explicitly support a certain network configuration ID. For example, in those cases where the network configuration ID is the same for a large number of neighboring cells, the UE may use the same model after performing a handover. Otherwise, if neighboring cells have different network configuration IDs, the overhead in loading and/or transferring (e.g., in block 460) a model that supports a different network configuration ID might not motivate the handover gain.

In additional or alternative embodiments, the UE can pre-deploy models that support the network configuration ID of other cells prior to handover, which would enable the UE to quickly utilize the model after handover. The decision of which models to pre-deploy could also be based on mobility prediction at the device, e.g., when the UE is moving towards a certain cell with associated network configuration ID.

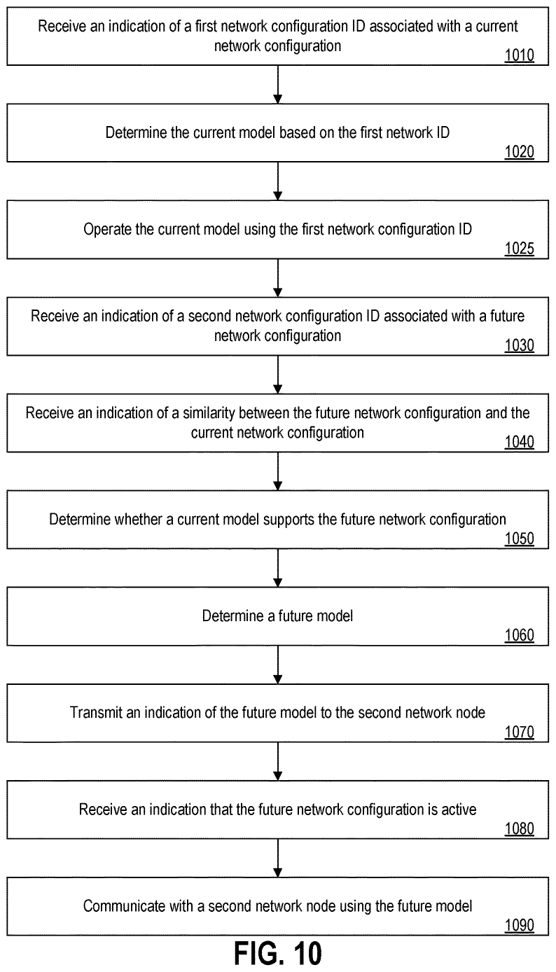

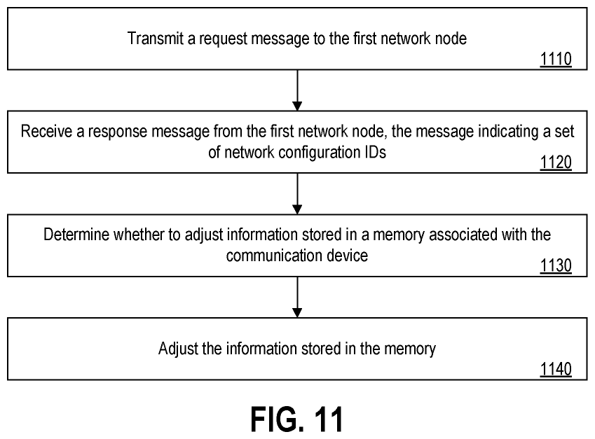

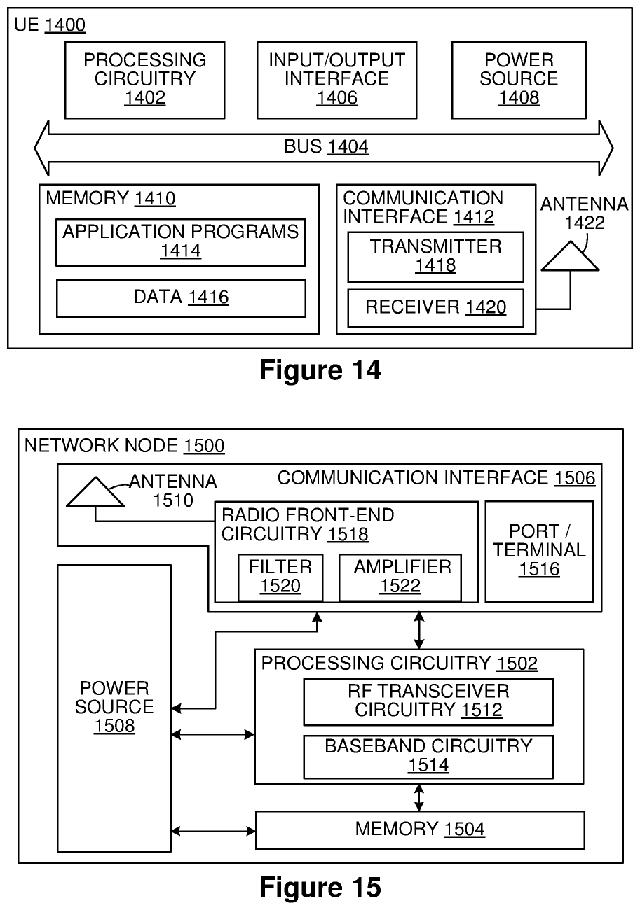

Operations of the communication device 1400 (implemented using the structure of the block diagram of FIG. 14) will now be discussed with reference to the flow chart of FIGS. 10-11 according to some embodiments of inventive concepts. For example, modules may be stored in memory 1410 of FIG. 14, and these modules may provide instructions so that when the instructions of a module are executed by respective communication device processing circuitry 1402, processing circuitry 1402 performs respective operations of the flow charts.

FIG. 10 illustrates an example of operations performed by a communication device according to some embodiments. In this example, the communication device is in a communications network that includes a first network node.

At block 1010, processing circuitry 1402 receives, via communication interface 1412, an indication of a first network configuration ID associated with a current network configuration.

At block 1020, processing circuitry 1402 determines the current model based on the first network ID.

At block 1025, processing circuitry 1402 operates the current model using the first network configuration ID. For example, the first network configuration ID can be used as input to the current model.

At block 1030, processing circuitry 1402 receives, via communication interface 1412, an indication of a second network configuration ID associated with a future network configuration.

At block 1040, processing circuitry 1402 receives, via communication interface 1412, an indication of a similarity between the future network configuration and a third network configuration. In some examples, the third network configuration is the current network configuration. Determining whether the current model supports the future network configuration can include determining whether the current model supports the future network configuration based on the similarity between the future network configuration and the active network configuration.

In additional or alternative examples, the third network configuration is different from the current network configuration. The third network configuration may be associated with a third network configuration ID and/or third model that is known to the communication device. Determining the future model can include, responsive to the similarity being above a threshold value, determining the future model is a third model that is associated with the third network configuration.

At block 1050, processing circuitry 1402 determines whether a current model supports the future network configuration.

At block 1060, processing circuitry 1402 determines a future model. In some embodiments, determining whether the current model supports the future network configuration includes determining that the current model supports the future network configuration. In some examples, the future model can be determined to be the current model.

In additional or alternative embodiments, determining whether the current model supports the future network configuration includes determining that the current model fails to support the future network configuration. In some examples, determining the future model includes selecting the future model from a local model database based on the network configuration ID. In additional or alternative examples, determining the future model includes: transmitting a request to a remote model database based on the network configuration ID; and receiving a response from the remote model database indicating the future model.

At block 1070, processing circuitry 1402 transmits, via communication interface 1412, an indication of the future model to the second network node.

At block 1080, processing circuitry 1402 receives, via communication interface 1412, an indication of when the future network configuration will be active. In some embodiments, the indication indicates that the future network configuration is active. In some examples, the second network node is the first network node.

In additional or alternative embodiments, the second network node is a neighboring node to the first network node. The first network configuration ID is associated with a configuration of the first network node. The second network configuration ID is associated with a configuration of the second network node. Receiving the indication of when the future network configuration will be active includes receiving an indication of a handover of the communication device to the second network node.

At block 1090, processing circuitry 1402 communicates, via communication interface 1412, with a second network node using the future model.

In some embodiments, the models (e.g., the current model) each include a machine learning, ML, model configured to assist with communication between the communication device and the first network node.

FIG. 11 illustrates an example of additional or alternative operations performed by a communication device according to some embodiments.

At block 1110, processing circuitry 1402 transmits, via communication interface 1412, a request message to the first network node. In some embodiments, transmitting the request message includes transmitting the request message in response to at least one of: the memory associated with the communication device reaching a threshold amount of available capacity; the communication device being configured to receive a new model; a validity time associated with the first network configuration ID having elapsed; performing a handover; determining a change in tracking area, operator, or country code; and at a periodic time interval.

At block 1120, processing circuitry 1402 receives, via communication interface 1412, a response message from the first network node. The message indicates a set of network configuration IDs. In some embodiments, receiving the response message includes receiving the response message in response to transmitting the request message.

At block 1130, processing circuitry 1402 determines whether to adjust information stored in a memory associated with the communication device. In some embodiments, the response message further includes an indication of a probability of each of the network configurations being implemented. Determining whether to adjust the information can include determining whether to adjust the information based on the indication of the probability of each of the network configurations being implemented.

At block 1140, processing circuitry 1402 adjusts the information stored in the memory. In some embodiments, determining whether to adjust the information stored in the memory includes determining to delete a portion of the information. Adjusting the information can include, responsive to determining to delete the portion of the information, deleting the portion of the information.

In additional or alternative embodiments, determining whether to adjust the information stored in the memory includes determining to add new information to the information stored in the memory. Adjusting the information can include, responsive to determining to add the new information, storing the new information.

In some examples, the portion of the information or the new information includes a model associated with a network configuration ID.

Various operations from the flow chart of FIGS. 10-11 may be optional with respect to some embodiments of communication devices and related methods. In some embodiments, operations of blocks 1010, 1020, 1040, and 1070 of FIG. 10 and all blocks of FIG. 11 may be optional. In additional or alternative embodiments, operations of all blocks of FIG. 10 and blocks 1110 of FIG. 11 may be optional.

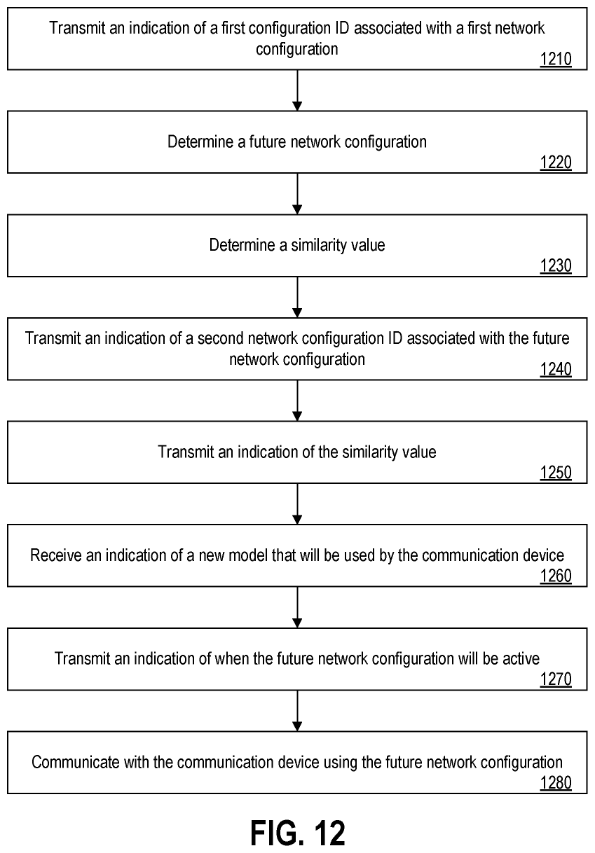

Operations of the RAN node 1500 (implemented using the structure of FIG. 15) will now be discussed with reference to the flow chart of FIG. 12 according to some embodiments of inventive concepts. For example, modules may be stored in memory 1504 of FIG. 15, and these modules may provide instructions so that when the instructions of a module are executed by respective RAN node processing circuitry 1420, RAN node 1500 performs respective operations of the flow chart.

FIG. 12 illustrates an example of operations performed by a network node according to some embodiments. In this example, the network node is in a communications network that includes a communication device.

At block 1210, processing circuitry 1502 transmits, via communication interface 1506, an indication of a first configuration ID associated with a first network configuration. In some examples, the first network configuration is a current network configuration. In other examples, the first network configuration is not a current network configuration and the first network configuration ID is associated with a model available to the communication device.

At block 1220, processing circuitry 1502 determines a future network configuration. In some embodiments, the network node is a first network node and the first network configuration is associated with a configuration of the first network node. The future network configuration can be associated with a configuration of a second network node that is a neighboring node to the first network node.

At block 1230, processing circuitry 1502 determines a similarity value. In some embodiments, determining the similarity value includes determining a similarity between the first network configuration ID and the second network configuration ID. In additional or alternative embodiments, determining the similarity value includes determining a similarity between the first network configuration and the future network configuration.

At block 1240, processing circuitry 1502 transmits, via communication interface 1506, an indication of a second network configuration ID associated with the future network configuration.

At block 1250, processing circuitry 1502 transmits, via communication interface 1506, an indication of the similarity value.

At block 1260, processing circuitry 1502 receives, via communication interface 1506, an indication of a new model that will be used by the communication device.

At block 1270, processing circuitry 1502 transmits, via communication interface 1506, an indication of when the future network configuration will be active.

At block 1280, processing circuitry 1502 communicates, via communication interface 1506, with the communication device using the future network configuration.

Various operations from the flow chart of FIG. 12 may be optional with respect to some embodiments of RAN nodes and related methods. In some embodiments, operations of blocks 1220, 1230, 1250, 1260, 1270, and 1280 of FIG. 12 may be optional.

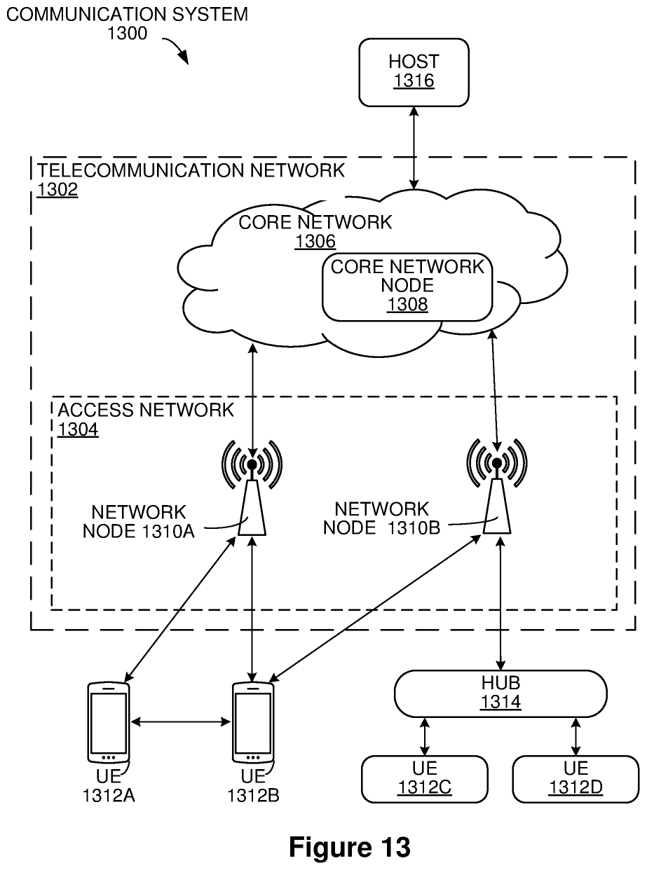

FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub-that is, a hub whose primary function is to route communications to/from the UEs from/to the network node 1310b. In other embodiments, the hub 1314 may be a non-dedicated hub-that is, a device which is capable of operating to route communications between the UEs and network node 1310b, but which is additionally capable of operating as a communication start and/or end point for certain data channels.

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510.

Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment.

Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

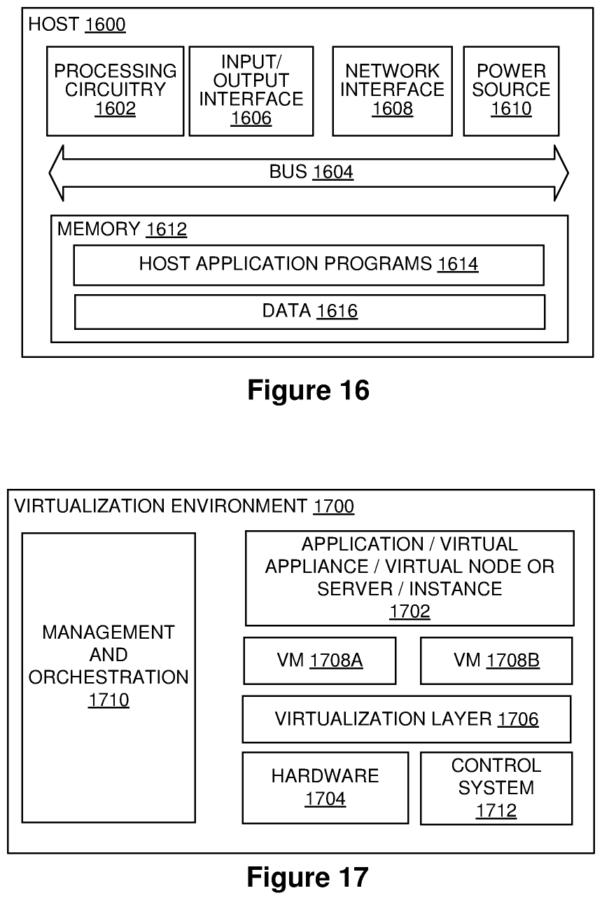

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top (OTT) services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706.

Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine.

Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization.

Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

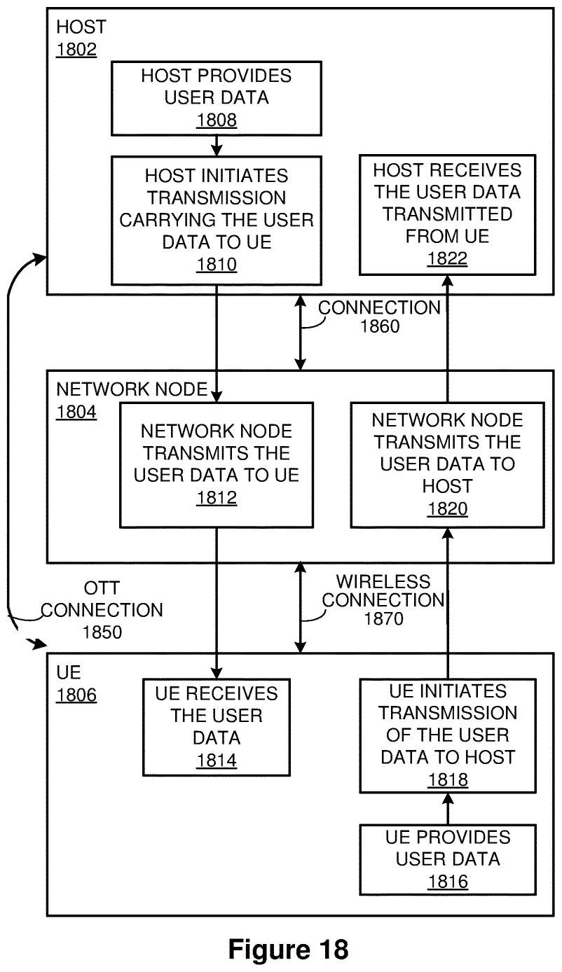

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve data rate and/or latency and thereby provide benefits such as reduced user waiting, better responsiveness, and improved user experience.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc. ; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.

Embodiment 1. A method of operating a communication device in a communications network that includes a first network node, the method comprising:
receiving (1030) an indication of a network configuration identifier, ID, from the first network node, the network configuration ID being associated with a future network configuration;
determining (1050) whether a current model supports the future network configuration;
determining (1060) a future model based on determining whether the current model supports the future network configuration;
receiving (1080) an indication of when the future network configuration will be active; and
subsequent to receiving the indication that the future network configuration is active, communicating (1090) with a second network node using the future model.

Embodiment 2. The method of Embodiment 1, wherein the network configuration ID is a second network configuration ID that is associated with the future network configuration, the method further comprising:
receiving (1010) a first network configuration ID that is associated with an active network configuration; and
determining (1020) the current model based on the first network configuration ID.

Embodiment 3. The method of Embodiment 2, further comprising:
receiving (1040) an indication of a similarity between the future network configuration and the active network configuration,
wherein determining whether the current model supports the future network configuration comprises determining whether the current model supports the future network configuration based on the similarity between the future network configuration and the active network configuration.

Embodiment 4. The method of any of Embodiments 1-3, further comprising:
operating (1025) the current model using the first network configuration identifier ID,
wherein communicating with the second network node using the future model comprises operating the future model using the second network configuration ID.

Embodiment 5. The method of any of Embodiments 1-4, further comprising:
receiving (1040) an indication of a similarity between the future network configuration and a third network configuration,
wherein determining the future model comprises, responsive to the similarity being above a threshold value, determining the future model is a third model that is associated with the third network configuration.

Embodiment 6. The method of any of Embodiments 1-5, wherein determining whether the current model supports the future network configuration comprises determining that the current model fails to support the future network configuration, and
wherein determining the future model comprises selecting the future model from a local model database based on the network configuration ID.

Embodiment 7. The method of any of Embodiments 1-5, wherein determining whether the current model supports the future network configuration comprises determining that the current model fails to support the future network configuration, and
wherein determining the future model comprises:
   transmitting a request to a remote model database based on the network configuration ID; and
   receiving a response from the remote model database indicating the future model.

Embodiment 8. The method of any of Embodiments 1-7, further comprising:
transmitting (1070) an indication of the future model to the second network node.

Embodiment 9. The method of any of Embodiments 1-8, wherein the current model comprises a machine learning, ML, model configured to assist with communication between the communication device and the first network node.

Embodiment 10. The method of any of Embodiments 1-9, wherein the second network node is a neighboring node to the first network node,
wherein the first network configuration ID is associated with a configuration of the first network node,
wherein the second network configuration ID is associated with a configuration of the second network node, and wherein receiving the indication of when the future network configuration will be active comprises receiving an indication of a handover of the communication device to the second network node.

Embodiment 11. The method of any of Embodiments 1-9, wherein the second network node is the first network node.

Embodiment 12. A method of operating a communication device in a communications network that includes a first network node, the method comprising:
receiving (1120) a message from the first network node, the message indicating a set of one or more network configuration identifiers, IDs, that are each associated with network configurations; and
determining (1130) whether to adjust information stored in a memory associated with the communication device based on the set of one or more network configuration IDs.

Embodiment 13. The method of Embodiment 12, further comprising:
transmitting (1110) a request message to the first network node, the first request message including a request for the set of one or more network configuration IDs, wherein receiving the response message comprises receiving the response message in response to transmitting the request message.

Embodiment 14. The method of Embodiment 13, wherein transmitting the request message comprises transmitting the request message in response to at least one of:
the memory associated with the communication device reaching a threshold amount of available capacity;
the communication device being configured to receive a new model;
a validity time associated with the first network configuration ID having elapsed;
performing a handover;
determining a change in tracking area, operator, or country code; and
at a periodic time interval.

Embodiment 15. The method of any of Embodiments 12-14, wherein the message further includes an indication of a probability of each of the network configurations being implemented, and
wherein determining whether to adjust the information comprises determining whether to adjust the information based on the indication of the probability of each of the network configurations being implemented.

Embodiment 16. The method of any of Embodiments 12-15, wherein determining whether to adjust the information stored in the memory comprises determining to delete a portion of the information, the method further comprising:
responsive to determining to delete the portion of the information, deleting (1140) the portion of the information.

Embodiment 17. The method of any of Embodiments 12-15, wherein determining whether to adjust the information stored in the memory comprises determining to add new information to the information stored in the memory,
the method further comprising:
   responsive to determining to add the new information, storing (1140) the new information.

Embodiment 18. The method of any of Embodiments 16-17, wherein the portion of the information or the new information comprises a model associated with a network configuration ID.

Embodiment 19. The method of any of Embodiments 12-18, further comprising any of the operations of Embodiments 1-11.

Embodiment 20. A method of operating a network node in a communications network that includes a communication device, the method comprising:
transmitting (1210) an indication of a first network configuration identifier, ID, to the communication device, the first network configuration ID being associated with a first network configuration; and
transmitting (1240) an indication of a second network configuration ID to the communication device, the second network configuration ID being associated with a future network configuration.

Embodiment 21. The method of Embodiment 20, further comprising:
determining (1230) a value based on at least one of:
   a similarity between the first network configuration ID and the second network configuration ID; and
   a similarity between the first network configuration and the future network configuration; and
transmitting (1250) an indication of the value to the communication device.

Embodiment 22. The method of any of Embodiments 20-21, wherein the first network configuration is a current network configuration.

Embodiment 23. The method of any of Embodiments 20-21, wherein the first network configuration is not a current network configuration, and
wherein the first network configuration ID is associated with a model available to the communication device.

Embodiment 24. The method of any of Embodiments 20-23, further comprising:
transmitting (1270) an indication of when the future network configuration will be active to the communication device; and
subsequent to transmitting the indication of when the future network configuration will be active, communicating (1280) with the communication device using the future network configuration.

Embodiment 25. The method of any of Embodiments 20-24, further comprising:
receiving (1260) an indication of a new model that will be used by the communication device in associate with the future network configuration.

Embodiment 26. The method of any of Embodiments 20-25, further comprising:
determining (1220) a future network configuration associated with a configuration of the network node.

Embodiment 27. The method of any of Embodiments 20-25, wherein the network node is a first network node,
wherein the first network configuration is associated with a configuration of the first network node, and
wherein the future network configuration is associated with a configuration of a second network node that is a neighboring node to the first network node.

Embodiment 28. A communication device (1400) communicatively coupled to a communications network, the communication device comprising:
processing circuitry (1402); and
memory (1410) coupled to the processing circuitry and having instructions stored therein that are executable by the processing circuitry to cause the communication device to perform operations comprising any of the operations of Embodiments 1-19.

Embodiment 29. A computer program comprising program code to be executed by processing circuitry (1402) of a communication device (1400) communicatively coupled to a communications network, whereby execution of the program code causes the communication device to perform operations comprising any operations of Embodiments 1-19.

Embodiment 30. A computer program product comprising a non-transitory storage medium (1410) including program code to be executed by processing circuitry (1402) of a communication device (1400) communicatively coupled to a communications network, whereby execution of the program code causes the communication device to perform operations comprising any operations of Embodiments 1-19.

Embodiment 31. A non-transitory computer-readable medium having instructions stored therein that are executable by processing circuitry (1402) of a communication device (1400) configured to perform operations comprising any of the operations of Embodiments 1-19.

Embodiment 32. A network node (1500), the network node comprising:
processing circuitry (1502); and
memory (1504) coupled to the processing circuitry and having instructions stored therein that are executable by the processing circuitry to cause the network node to perform operations comprising any of the operations of Embodiments 20-27.

Embodiment 33. A computer program comprising program code to be executed by processing circuitry (1502) of a network node (1500), whereby execution of the program code causes the network node to perform operations comprising any operations of Embodiments 20-27.

Embodiment 34. A computer program product comprising a non-transitory storage medium (1504) including program code to be executed by processing circuitry (1502) of a network node (1500), whereby execution of the program code causes the network node to perform operations comprising any operations of Embodiments 20-27

Embodiment 35. A non-transitory computer-readable medium having instructions stored therein that are executable by processing circuitry (1502) of a network node (1500) configured to perform operations comprising any of the operations of Embodiments 20-27

Embodiment 36. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   transmitting (1210) an indication of a first network configuration identifier, ID, to the communication device, the first network configuration ID being associated with a first network configuration; and
   transmitting (1240) an indication of a second network configuration ID to the communication device, the second network configuration ID being associated with a future network configuration.

Embodiment 37. The host of the previous Embodiment, wherein:
the processing circuitry of the host is configured to execute a host application that provides the user data; and
the UE comprises processing circuitry configured to execute a client application associated with the host application to receive the transmission of user data from the host.

Embodiment 38. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
transmitting (1210) an indication of a first network configuration identifier, ID, to the communication device, the first network configuration ID being associated with a first network configuration; and
transmitting (1240) an indication of a second network configuration ID to the communication device, the second network configuration ID being associated with a future network configuration.

Embodiment 39. The method of the previous Embodiment, further comprising, at the network node, transmitting the user data provided by the host for the UE.

Embodiment 40. The method of any of the previous 2 Embodiments, wherein the user data is provided at the host by executing a host application that interacts with a client application executing on the UE, the client application being associated with the host application.

Embodiment 41. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   transmitting (1210) an indication of a first network configuration identifier, ID, to the communication device, the first network configuration ID being associated with a first network configuration; and
   transmitting (1240) an indication of a second network configuration ID to the communication device, the second network configuration ID being associated with a future network configuration.

Embodiment 42. The communication system of the previous Embodiment, further comprising:
the network node; and/or
the user equipment.

Embodiment 43. The communication system of the previous 2 Embodiments, wherein:
the processing circuitry of the host is configured to execute a host application, thereby providing the user data; and
the host application is configured to interact with a client application executing on the UE, the client application being associated with the host application.

Embodiment 44. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
   transmitting (1210) an indication of a first network configuration identifier, ID, to the communication device, the first network configuration ID being associated with a first network configuration; and
   transmitting (1240) an indication of a second network configuration ID to the communication device, the second network configuration ID being associated with a future network configuration.

Embodiment 45. The host of the previous 2 Embodiments, wherein:
the processing circuitry of the host is configured to execute a host application, thereby providing the user data; and
the host application is configured to interact with a client application executing on the UE, the client application being associated with the host application.

Embodiment 46. The host of the any of the previous 2 Embodiments, wherein the initiating receipt of the user data comprises requesting the user data.

Embodiment 47. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   transmitting (1210) an indication of a first network configuration identifier, ID, to the communication device, the first network configuration ID being associated with a first network configuration; and
   transmitting (1240) an indication of a second network configuration ID to the communication device, the second network configuration ID being associated with a future network configuration.

Embodiment 48. The method of the previous Embodiment, further comprising at the network node, transmitting the received user data to the host.

Embodiment 49. A host configured to operate in a communication system to provide an over-the-top (OTT) service, the host comprising:
processing circuitry configured to provide user data; and
a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   receiving (1030) an indication of a network configuration identifier, ID, from the first network node, the network configuration ID being associated with a future network configuration;
   determining (1050) whether a current model supports the future network configuration;
   determining (1060) a future model based on determining whether the current model supports the future network configuration;
   receiving (1080) an indication of when the future network configuration will be active; subsequent to receiving the indication that the future network configuration is active, communicating (1090) with a second network node using the future model.

Embodiment 50. The host of the previous Embodiment, wherein the cellular network further includes a network node configured to communicate with the UE to transmit the user data to the UE from the host.

Embodiment 51. The host of the previous 2 Embodiments, wherein:
the processing circuitry of the host is configured to execute a host application, thereby providing the user data; and
the host application is configured to interact with a client application executing on the UE, the client application being associated with the host application.

Embodiment 52. A method implemented by a host operating in a communication system that further includes a network node and a user equipment (UE), the method comprising:
providing user data for the UE; and
initiating a transmission carrying the user data to the UE via a cellular network comprising the network node, wherein the UE performs the following operations to receive the user data from the host:
   receiving (1030) an indication of a network configuration identifier, ID, from the first network node, the network configuration ID being associated with a future network configuration;
   determining (1050) whether a current model supports the future network configuration;
   determining (1060) a future model based on determining whether the current model supports the future network configuration;
   receiving (1080) an indication of when the future network configuration will be active;
   subsequent to receiving the indication that the future network configuration is active, communicating (1090) with a second network node using the future model.

Embodiment 53. The method of the previous Embodiment, further comprising:
at the host, executing a host application associated with a client application executing on the UE to receive the user data from the UE.

Embodiment 54. The method of the previous Embodiment, further comprising:
at the host, transmitting input data to the client application executing on the UE, the input data being provided by executing the host application,
wherein the user data is provided by the client application in response to the input data from the host application.

Embodiment 55. A host configured to operate in a communication system to provide an over-the-top (OTT) service, the host comprising:
processing circuitry configured to utilize user data; and
a network interface configured to receipt of transmission of the user data to a cellular network for transmission to a user equipment (UE),
wherein the UE comprises a communication interface and processing circuitry, the communication interface and processing circuitry of the UE being configured to perform the following operations to transmit the user data to the host:
   receiving (1030) an indication of a network configuration identifier, ID, from the first network node, the network configuration ID being associated with a future network configuration;
   determining (1050) whether a current model supports the future network configuration;
   determining (1060) a future model based on determining whether the current model supports the future network configuration;
   receiving (1080) an indication of when the future network configuration will be active;
   subsequent to receiving the indication that the future network configuration is active, communicating (1090) with a second network node using the future model.

Embodiment 56. The host of the previous Embodiment, wherein the cellular network further includes a network node configured to communicate with the UE to transmit the user data from the UE to the host.

Embodiment 57. The host of the previous 2 Embodiments, wherein:
the processing circuitry of the host is configured to execute a host application, thereby providing the user data; and
the host application is configured to interact with a client application executing on the UE, the client application being associated with the host application.

Embodiment 58. A method implemented by a host configured to operate in a communication system that further includes a network node and a user equipment (UE), the method comprising:
at the host, receiving user data transmitted to the host via the network node by the UE, wherein the UE performs the following operations to transmit the user data to the host:
   receiving (1030) an indication of a network configuration identifier, ID, from the first network node, the network configuration ID being associated with a future network configuration;
   determining (1050) whether a current model supports the future network configuration;
   determining (1060) a future model based on determining whether the current model supports the future network configuration;
   receiving (1080) an indication of when the future network configuration will be active; subsequent to receiving the indication that the future network configuration is active, communicating (1090) with a second network node using the future model.

Embodiment 59. The method of the previous Embodiment, further comprising:
at the host, executing a host application associated with a client application executing on the UE to receive the user data from the UE.

Embodiment 60. The method of the previous Embodiments, further comprising:
at the host, transmitting input data to the client application executing on the UE, the input data being provided by executing the host application,
wherein the user data is provided by the client application in response to the input data from the host application.

1. A method of operating a communication device in a communications network that includes a first network node, the method comprising:
receiving an indication of a network configuration identifier, ID, from the first network node, the network configuration ID being associated with a future network configuration;
determining whether a current model supports the future network configuration;
determining a future model based on determining whether the current model supports the future network configuration;
receiving an indication of when the future network configuration will be active; and
subsequent to receiving the indication that the future network configuration is active, communicating with a second network node using the future model.

2. The method of claim 1, wherein the network configuration ID is a second network configuration ID that is associated with the future network configuration,
the method further comprising:
receiving a first network configuration ID that is associated with an active network configuration; and
determining the current model based on the first network configuration ID.

3. The method of claim 2, further comprising:
receiving an indication of a similarity between the future network configuration and the active network configuration,
wherein determining whether the current model supports the future network configuration comprises determining whether the current model supports the future network configuration based on the similarity between the future network configuration and the active network configuration.

4. The method of claim 1, further comprising:
operating the current model using the first network configuration identifier ID, wherein communicating with the second network node using the future model comprises operating the future model using the second network configuration ID.

5. The method of claim 1, further comprising:
receiving an indication of a similarity between the future network configuration and a third network configuration,
wherein determining the future model comprises, responsive to the similarity being above a threshold value, determining the future model is a third model that is associated with the third network configuration.

6. The method of claim 1, wherein determining whether the current model supports the future network configuration comprises determining that the current model fails to support the future network configuration, and
wherein determining the future model comprises selecting the future model from a local model database based on the network configuration ID.

7. The method of claim 1, wherein determining whether the current model supports the future network configuration comprises determining that the current model fails to support the future network configuration, and
wherein determining the future model comprises:
transmitting a request to a remote model database based on the network configuration ID; and
receiving a response from the remote model database indicating the future model.

8. The method of claim 1, further comprising:
transmitting an indication of the future model to the second network node.

9. The method of claim 1, wherein the current model comprises a machine learning, ML, model configured to assist with communication between the communication device and the first network node.

10. The method of claim 1, wherein the second network node is a neighboring node to the first network node,
wherein the first network configuration ID is associated with a configuration of the first network node,
wherein the second network configuration ID is associated with a configuration of the second network node, and
wherein receiving the indication of when the future network configuration will be active comprises receiving an indication of a handover of the communication device to the second network node.

11-19. (canceled)

20. A method of operating a network node in a communications network that includes a communication device, the method comprising:
transmitting an indication of a first network configuration identifier, ID, to the communication device, the first network configuration ID being associated with a first network configuration; and
transmitting an indication of a second network configuration ID to the communication device, the second network configuration ID being associated with a future network configuration.

21. The method of claim 20, further comprising:
determining a value based on at least one of:
a similarity between the first network configuration ID and the second network configuration ID; and
a similarity between the first network configuration and the future network configuration; and
transmitting an indication of the value to the communication device.

22. The method of claim 20, wherein the first network configuration is a current network configuration.

23. The method of claim 20, wherein the first network configuration is not a current network configuration, and
wherein the first network configuration ID is associated with a model available to the communication device.

24. The method of claim 20, further comprising:
transmitting an indication of when the future network configuration will be active to the communication device; and
subsequent to transmitting the indication of when the future network configuration will be active, communicating with the communication device using the future network configuration.

25. The method of any claim 20, further comprising:
receiving an indication of a new model that will be used by the communication device in associate with the future network configuration.

26. The method of claim 20, further comprising:
determining a future network configuration associated with a configuration of the network node.

27. The method of claim 20, wherein the network node is a first network node,
wherein the first network configuration is associated with a configuration of the first network node, and
wherein the future network configuration is associated with a configuration of a second network node that is a neighboring node to the first network node.

28. A communication device configured to perform operations comprising:
receiving an indication of a network configuration identifier, ID, from the first network node, the network configuration ID being associated with a future network configuration;
determining whether a current model supports the future network configuration;
determining a future model based on determining whether the current model supports the future network configuration;
receiving an indication of when the future network configuration will be active; and
subsequent to receiving the indication that the future network configuration is active, communicating with a second network node using the future model.

29. The communication device of claim 28, wherein the network configuration ID is a second network configuration ID that is associated with the future network configuration,
the method further comprising:
receiving a first network configuration ID that is associated with an active network configuration; and
determining the current model based on the first network configuration ID.

30-39. (canceled)
